(19) United States
(12) Patent Application Publication
(10) Pub. No.: US 2006/0294138 A1
(43) Pub. Date: Dec. 28, 2006

(54) Professional rating system and method

(76) Inventor: Lucas Stolba, Vancouver (CA)

Correspondence Address: Fasken Martineau DuMoulin LLP, 2100 - 1075 West Georgia Street, Vancouver, BC, V6E 3G2, CA

(21) Appl. No.: 11/165,502

(22) Filed: Jun. 24, 2005

(51) Int. Cl. G06F 17/00

(52) U.S. Cl. 707/104.1

(57) ABSTRACT

A system for rating professionals is provided, comprising: (a) means for storing information about a plurality of professionals in a database, including a name and contact information of each of said professionals; (b) means for a user to search said database via a web site; (c) means for said user provide the name and contact information of a professional to said database; and (d) means for said user to provide a rating of said professional. The rating may be based on the expertise of said professional, the cost of said professional or the ethics of said professional, and may include a comment about the professional. The web site preferably has means for said user to search said database by selecting a category of professionals, a subcategory of professionals and a geographic area for said professional.

### FIELD OF THE INVENTION

The invention relates to Internet based review web sites, and more particularly to web sites relating to professional criteria.

### BACKGROUND OF THE INVENTION

The Internet and World Wide Web have enabled users to share information about products that was previously difficult to do and was once confined to specific publications, such as Consumer Reports. There are now web sites available to help users learn about available products. Many sites that retail such products include opportunities for purchasers to provide ratings and comments about the products. These sites give new prospective customers an opportunity to compare products before making a purchase.

There are also some web sites, which exist to collect opinions about different products or services and posting them for the future reference of others. The Internet has made this information accessible worldwide, and these sites provide consumers the tools for finding the best products according to their requirements, and avoiding poorly reviewed or rated products.

The collection of comments and remarks for future reference helps generate a healthy competition among the producers of these products. The benefit to consumers includes lower prices, better service, and the ability to avoid poor products.

Computers and web sites are used to compare predicted results and actual results of professional services, taking the difference and posting a comment for future reference, as described in U.S. Patent Application Publication No. 2003/00416169, entitled “Procurement and Management of Professional Services”, by Fraser et al. U.S. Patent Application Publication No. 2002/0156857 to Brewer at el. describes an on line procedure for acquiring bids from service providers, making a comparison, and making a decision. These solutions deal with very specific professional services in very specific ways.

U.S. Patent Application Publication No. 2002/0038233 to Shubov et al., discloses a system and method for matching professional service providers with consumers”; and U.S. Patent Application Publication No. 2003/0163349 discloses a quality rating tool for the healthcare industry describe solutions specifically qualified users.

Other related art includes: U.S. Patent Application Publication No. 2004/0172282 to Benja-Athon; U.S. Patent Application Publication No. 2002/0038233 to Shubov et al.; U.S. Patent Application Publication No. 2003/0163349 to Ho; U.S. Patent Application Publication No. 2004/0220842 to Barney; U.S. Patent Application Publication No. 2004/0133463 to Benderev; U.S. Patent Application Publication No. 2003/0046169 to Fraser et al.; U.S. Patent Application Publication No. 2001/0037219 to Malik; U.S. Patent Application Publication No. 2002/0156857 to Brewer et al.; and U.S. Patent Application Publication No. 2003/0216938 to Shour.

### BRIEF SUMMARY OF THE INVENTION

The invention provides an Internet web site that allows users to leave comments, ratings and opinions about professionals. The comments will be available for future reference, on that particular professional. People will be able to rate and comment about any sort of professional. A searchable database of all the professions will be the visitors, this data base will not only provide the basic information about the professional but also bring up the previous ratings and comments submitted by different people. The visitors will also be able to add their comments through a manual entry procedure.

A method of rating a professional is provided comprising: (a) providing a database, said database containing a plurality of records, each of said records relating to a professional, each of said records storing the name and contact information of said professional; (b) searching through said database for a particular professional using a web site; (c) if said professional is present in a record in said database, providing a rating for said professional; and (d) if said professional is not present in a record in said database, providing the name and contact information of said professional to said database, and providing a rating and/or a comment for said professional. The rating may be based on the expertise of said professional, the cost of said professional or the ethics of said professional. The search may be accomplished by selecting a category of professionals, selecting a subcategory of professionals and selecting a geographic area for said professional.

The web site is preferably accessible to users searching for said rating of said professional and provides an advertisement. A second professional may bid on said advertisement, and if successful in said bid, may select said advertisement for display on said web site.

A system for rating professionals is provided, comprising: (a) means for storing information about a plurality of professionals in a database, including a name and contact information of each of said professionals; (b) means for a user to search said database via a web site; (c) means for said user provide the name and contact information of a professional to said database; and (d) means for said user to provide a rating of said professional.

The rating may be based on the expertise of said professional, the cost of said professional or the ethics of said professional, and may include a comment about the professional. The web site preferably has means for said user to search said database by selecting a category of professionals, a subcategory of professionals and a geographic area for said professional.

The web site is preferably accessible to a second user to access said rating of said professional and provides an advertisement. A second professional may bid on said advertisement, and if successful in said bid, may select said advertisement for display on said web site.

### BRIEF DESCRIPTION OF THE DRAWINGS

FIG. 1 is flow chart of an embodiment of the invention, showing the flow of information and the major components of a preferred embodiment of a web site according to the invention;

FIG. 2 is a flow chart showing the flow of information of the search process and the components thereof;

FIG. 3 is a flow chart showing the components and flow of information when adding the name of a professional;

FIG. 4 is a flowchart showing the components and the flow of information when adding a comment about a professional;

FIG. 5 is a flowchart showing the procedure of logging in with a user ID, and also the registration process for acquiring a user ID;

FIG. 6 is flow chart showing the components and the flow of information for posting a resume or an advertisement;

FIG. 7 is a flowchart showing the flow of information for the bidding process; and

FIG. 8 is a block diagram showing an implementation of a preferred embodiment of a system according to the invention.

### DETAILED DESCRIPTION OF THE INVENTION

In the present specification and claims, the following terms will have the following meanings:

“home page” is a web page on a web site to which a user typically first hyperlinks to;

“professional” means an individual or organization, such as a company or partnership, that provides professional services to others for a price based on time spent or the services to be provided. Examples of professionals include such traditional professions as doctors, lawyers, accountants, as well as plumbers, electricians, contractors, etc., but excludes teachers, professors, and retailers.

“user” means an entity capable of using the professional rating system and includes software agents and software robots;

“via” means by means of;

“web page” is a document on the World Wide Web (or Internet). Every web page is identified by a unique Uniform Resource Locator (URL). A web page is a file readable by web browsers and may contain prompts to the user including common user interface controls such as data entry fields, list boxes, drop-down boxes, check boxes, push buttons, radio buttons and the like. In a preferred embodiment, HTML and XML scripts are used to display the pages and accept data from users via the web browser. Using hypertext, a link is a selectable connection from one word, picture, or information object to another. In a multimedia environment such as the World Wide Web, such objects can include sound and motion video sequences. The most common form of link is the highlighted word or picture that can be selected by the user (with a mouse or in some other fashion), resulting in the immediate delivery and view of another file. The highlighted object is the anchor. The anchor reference and the object referred to, constitute a hypertext link; and

“web site” means a unique location on the World Wide Web containing a home page, and also includes non-computer analogues, like URLs printed into the pixels of paper advertisements.

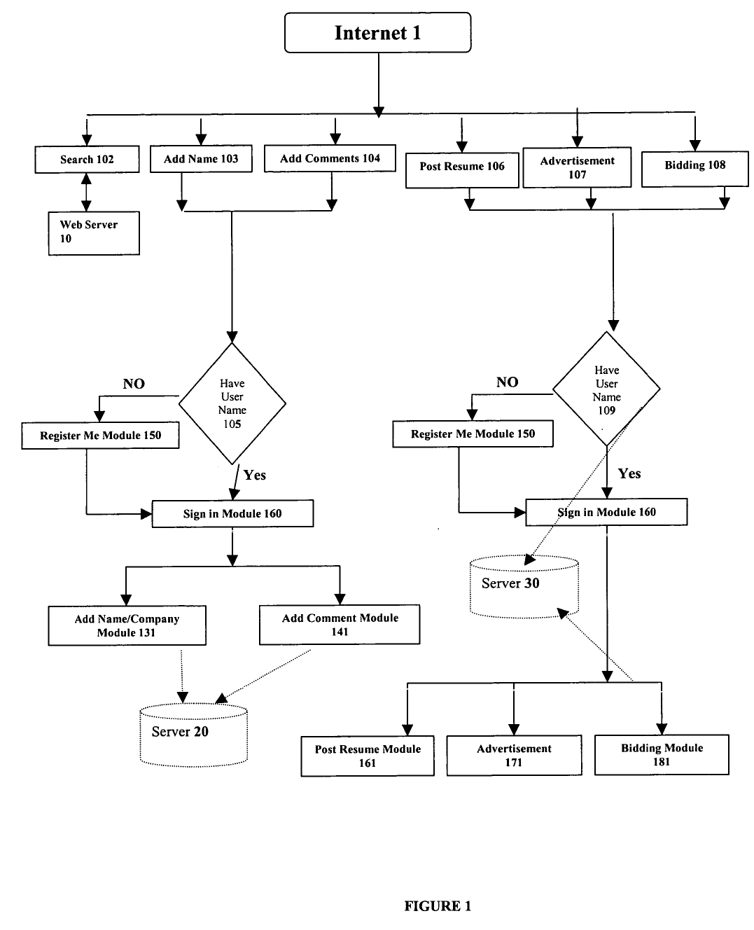

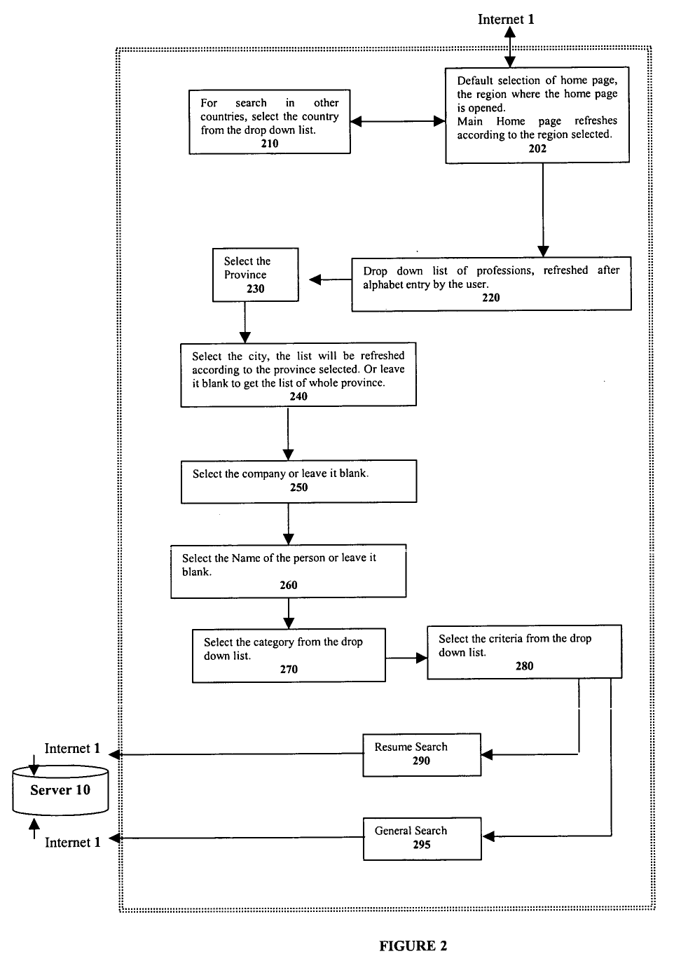

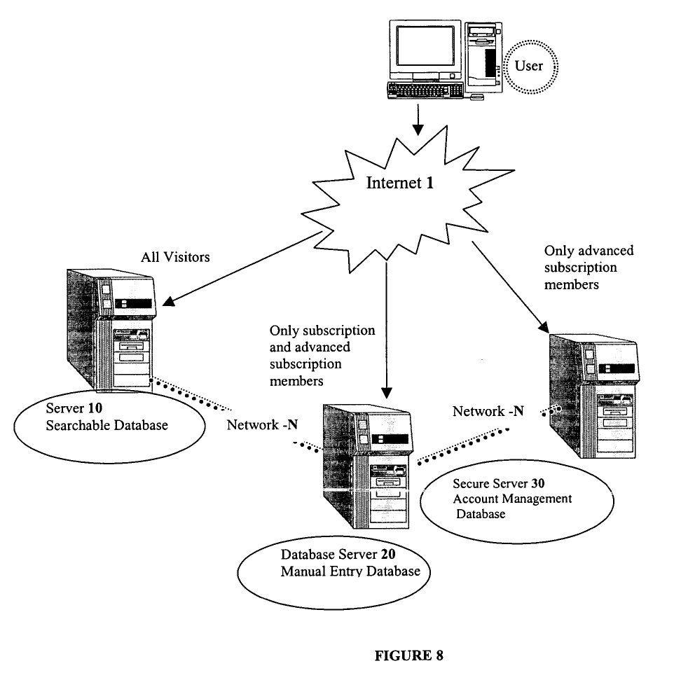

The system according to the invention is preferably implemented using a web site accessible via the Internet and World Wide Web as seen in FIG. 8. FIG. 8 shows a preferred embodiment of the system, in which user 80 is able to connect to web server 10 via the Internet 1. Web server 10 stores the web site and contains the searchable database accessible to users 80. User 80 will be able to perform a search using search module 25 (described below and with reference to FIGS. 1 and 2) and obtain the search results from web server 10. The user may submit a new professional name or company using the appropriate module to the database or submit a comment using the appropriate module. In a preferred embodiment, only users that subscribe to the web site (herein referred to as subscription users) will be able to submit such information to database server 20. This submitted information would later be refreshed and stored in web server 10, and become a part of the searchable database for future searches.

In the preferred embodiment, subscription users may post resumes using the post resume module 60, purchase advertisements using the purchase advertising module 70 and bid using the bidding module 80 for the opportunity to place advertisements and this information submitted by the subscription users will be stored in secure server 30. Secure server 30 stores all the financial information submitted by users on secure pages. All three servers, web server 10, database server 20 and secure server 30 are connected to each other via network N. All users can access web server 10. In a preferred embodiment users that are not subscribers will be able to access web server 10 but not database server 20, whereas, subscription users will be able to access database server 20. Only subscriber users who also submit financial information (herein referred to as “advanced subscription users”) will have access to secure server 30.

Web server 10, database server 20 and secure server 30 may be conventional servers, having input means, such as a mouse and keyboard, output means, such as a monitor and speakers, a CPU, RAM, and a hard drive. Furthermore, servers 10, 20 and 30 have means to communicate with each other and with the Internet, such as a modem. In an alternative embodiment all three servers may be on a single computer. User 80 will typically be using a computer from which user 80 can access the Internet, typically a PC, but optionally may be using a PDA, a Blackberry device, or a cellular phone.

The web site on web server 10 will allow the sharing of information with other users and will assist them in making decisions about using a professional. The web site will allow users to obtain categorized information about different professionals (for example their skill level, customer service level, events, etc.).

For example, a user may be considering going to a dentist and may want to know who is the best dentist in his or her area. To obtain this information, the user can access the web site and select the search criteria to obtain the desired details. Users will be at liberty to share their comments, good or bad, about any services received from the professionals. Users 80 will also have an outlet for their frustration if they have had a bad experience in dealing with a professional.

The web site enables users 80 to leave and share their good and bad comments about any specific professionals, but also provides an automatic responder that generates a message via email for that particular professional asking him or her to log onto the web site and view the comments. Should the professional so desire, they can post a response to the comment as well (the professionals can also be notified by phone using prerecorded voice messages). The comments from users 80 can also be used by the professionals to improve their services. The web site may also provide a platform for users 80 to find or to share their remarks about professionals in specific areas. This will not only help those professionals improve their services, but may also attract users 80 to high quality but less well known professionals.

As seen in FIG. 1, when a user using an Internet browser connects to the web page, a number of options for selection will be presented to them. One available option will be for user to search through the searchable database. When a user elects to search (step 102), the system sends the results to web server 10 and displays them to the user's browser. The options to add a professional's name (step 103) or to add comments (step 104) are only available to subscription users who must enter their user ID and password. If a user 80 selects the options to add a name (step 103) or add a comment (step 104), the system will prompt the user 80 with a question as to whether they have a user ID (step 105). If the user responds yes, then a sign in process (step 160) is presented to user 80, otherwise the registration process (step 150) is provided in order for the user 80 to obtain a user ID.

After the user 80 has logged into to the web site, then the add name/company process (step 131) and the add comment process (step 141) will be accessible. The information added by user 80 will be stored in the database server 20 and will be added to web server 10 for future searches.

Should a user wish to post a resume (step 106), post an introductory advertisement (step 107) or participate in an advertisement bidding process (step 108), the system will again prompt the user to inquire if they have a user ID (step 109). If the answer provided is no, then a registration process (step 109) is provided to user 80 acquire the user ID. If the user has already acquired a user ID through the registration process 150, the user will have to provide some additional information in order to gain further access. After the user has provided the necessary information, they can access the processes for posting a resume (step 161), posting an advertisement (step 171) and participating in bidding (step 181). All of these processes provide information to secure server 30 for storage. The user ID acquired through the registration module 150 will only provide limited access; and will enable the user to access the “manual entry” processes of adding the name of a professional or company (step 131) and adding a comment (step 141).

As seen in FIG. 2 the default selection of the web page featuring the search (step 202) will correspond to the country from where the Internet 1 is accessed. For example a “.com” web site will default to the United States, whereas a “.ca” web site will default to Canada. However, user 80 can select the name of a different country (step 210) to perform a search in such country. The search web page will refresh according to the country selection. This option should be available to all users. To conduct a search for a particular professional, the user enters the first three letters representing the profession and the system displays a drop down the list of applicable professions (step 220) depending on the entered letters. Some professions may be represented by several different combinations, for example lawyers would appear on the list corresponding to “LAW”, as well as those corresponding to “BAR” (barristers) and “SOL” (solicitors). User 80 selects the desired profession from the drop down list (step 220) and then selects the applicable province or state (step 230) and city (step 240). The selection of city (step 240) and state/province (step 230) is optional, to help narrow down the search. In the case where the city is left blank, the results for the entire state/province will be displayed. The user can also select a company name (step 250) and/or a particular professional individual's name (step 260). In these fields are left blank then all of the professionals meeting the selected criteria (geographically and in the appropriate profession) are displayed. From this display, the user can further select the category (step 270) and criteria (step 280). The category represents the type of professional, e.g. accountant, lawyer, doctor, etc. and the criteria represents a particular subgroup selection, for example, the top ten rated, or the most frequently most voted for, or the least expensive. There are preferably at least two main searchable databases accessible via the web site, one for resumes and the other for professionals. If the search requested is for a resume (step 290) then only resumes corresponding to the search criteria will be displayed. If the search is a general search for a professional (step 295), all available information about the professional will be displayed. In a preferred embodiment, resumes are excluded when displaying all of the information about the professionals to avoid cluttering the web page and to accelerate the provision of the search results. After the search has been conducted, the results are sent to and displayed on the user's browser.

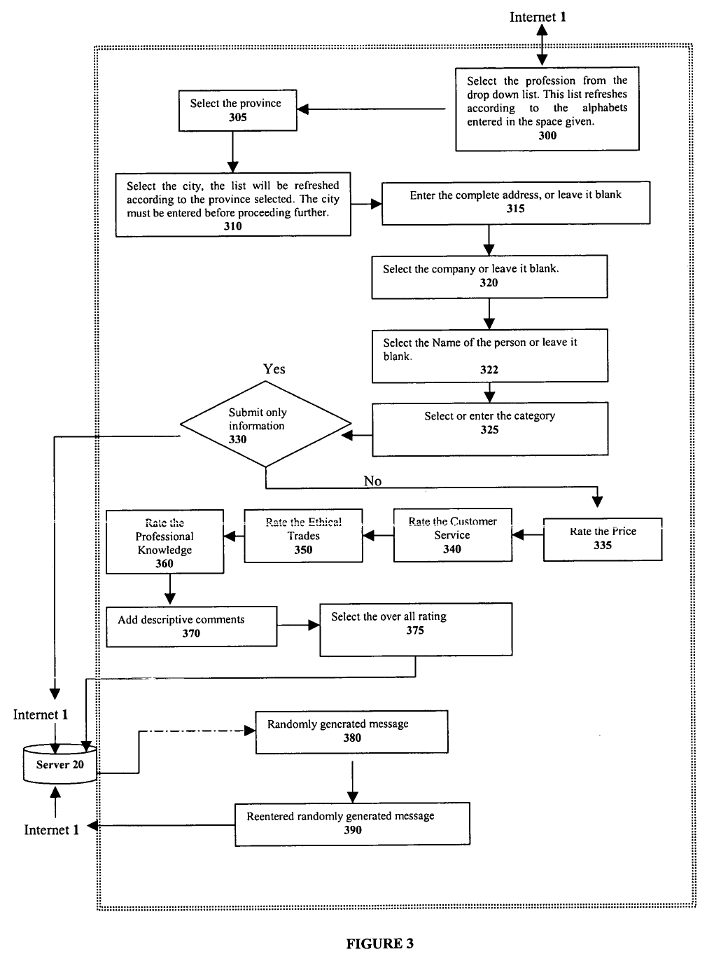

A subscription user 80 can add a professional name, a professional company or a new profession, as seen in FIG. 3. If the search fails to locate a desired professional, then user 80 can add the name of a professional, as well as related individual professionals (for example professional employees at a professional firm). Preferably this service is available only to subscription users. When this process is accessed the subscription user 80 enters the first three letters in the name of the profession to obtain a list of corresponding professions (step 300). This brings forward the entire main category and subcategories related to the entered letters. The category as previously described will be the general type of professional, for example accountant, doctor or the like. The subcategory is the different subsets of professionals in the main category. For example, different medical specialties could be subsets of the category “doctor”. Likewise, different legal specialties could be subsets of the category “lawyer”. The user then selects the province/state of the professional (step 305) and the city (step 310). As these are related, the drop down city list is refreshed to correspond to the selected province, but preferably both entries are mandatory. After these selections the user provides the address of the professional (step 315), the name of the professional entity (step 320) and/or the individual professional (step 322) and the category (step 325) as described above. After providing this information, the user has the option of only submitting this information, or also providing a comment (step 330). Should the user select the option to add comments, the user is prompted to, and provides a rating for the price of the professional service (step 335), the customer service of the professional (step 340), their ethics (step 350) and their professional knowledge (step 360). After providing the ratings, the user 80 can add descriptive comments (step 370) and an over all rating (step 375). Once the over all rating is submitted, database server 20 generates a random message (step 380) which is sent to user 80, and which user 80 re-enters (step 390) to complete the process. This step provides additional security and can be used to prevent automated software “engines” from submitting information, although other tools known in the art can be used for this purpose. The completed record is then stored in database server 20 and copied to server 10 for future searches.

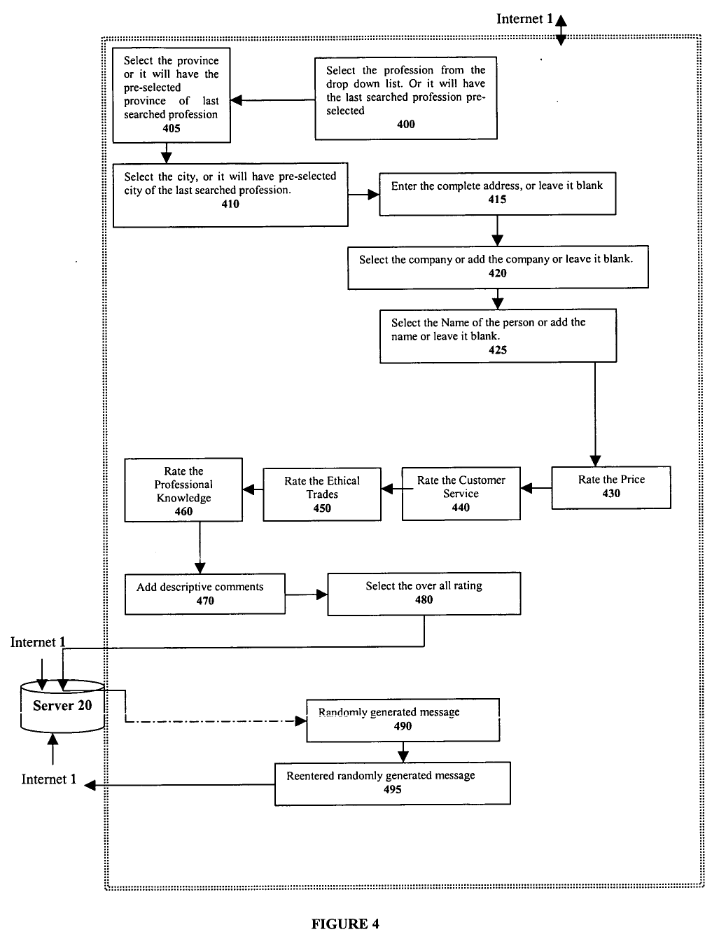

Users can leave comments and remarks about professionals as shown in FIG. 4. This module could be accessed either after a search or directly by selecting the add comment option from the web site. Preferably only subscriber users can leave comments. If the add comment module is called after a search then the results of the search will be completed in the fields relating to profession, province/state and city. If the add comment module is called by the selection of the add comment option then such fields will be blank and would be completed by the user 80. As described previously, if the add comment option is selected and the module called, then the user 80 begins by entering the first three letters in the spelling of the profession (step 400), bringing up a drop down list of professions corresponding to the selected letters. This list will contain the entire main category and subcategories of professions. After selecting the province/state (step 405) the city list is refreshed and cities corresponding to the selected province/state are made available in the drop down city list for selection (step 410). After the appropriate city is selected, the professional's address is entered (step 415), and then the professional entity's name is selected from the drop down list provided (step 420). If the professional's name is not available in drop down list then the user can select the “add professional entity” option from the drop down list. The user can then select the skilled individual name (if the professional is in a group of professionals) (step 425) or may select the option from the drop down list to add a name. The user may then rate the selected professional by price (step 430), by customer service (step 440), by ethics (step 450) and/or professional knowledge (step 460). The user can also provide comments by typing in the appropriate area (step 470), and select an overall rating (step 480). When the over all rating is selected the system generates a random message (step 490) provided through web server 20, that is re-entered (step 495) by user 80 and submitted to the web server 20 via the user's browser.

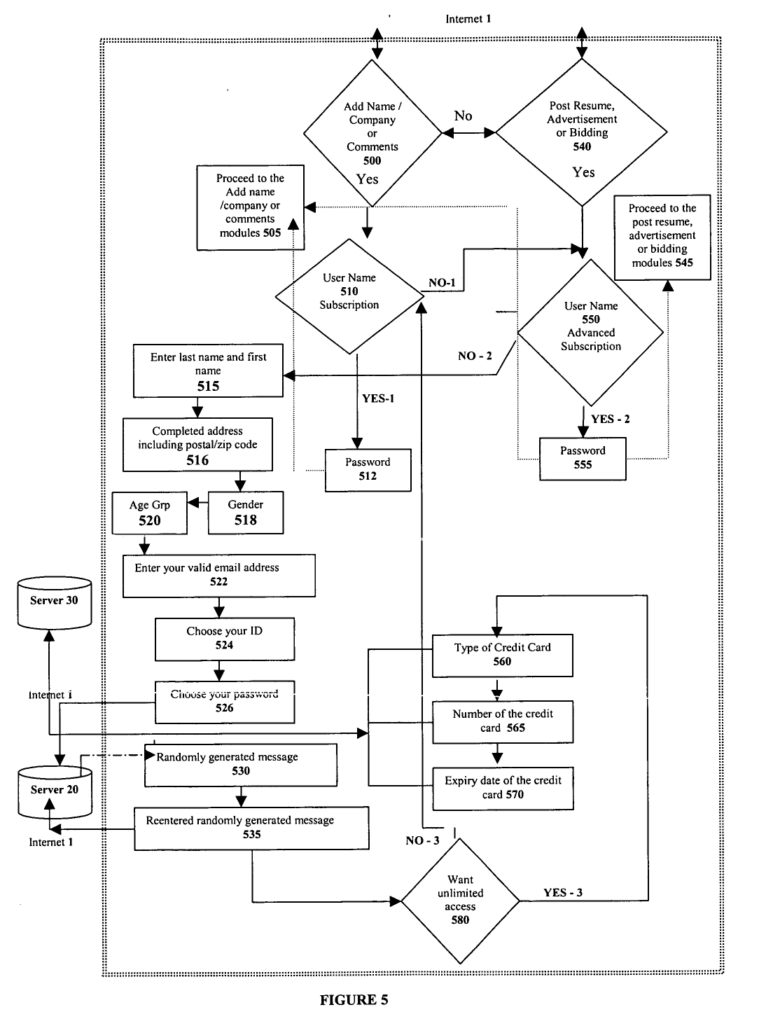

As seen in FIG. 5 the user may add a professional services name/company; add a comment; post a resume; post an advertisement; and bid for the opportunity to place an advertisement. There are preferably two levels of subscription users. The two levels are regular subscription users, which have access to the manual entry modules, add name/company modules, and the add comment module; and advanced subscription users, which have access to the above mentioned modules as well as the post resume module; advertisement module; and bidding module. When a user selects to access a module other the search module, the system checks the selected option to determine the level required for access. In case the selection is one of the add professional name/company module or comments module (step 500), the system asks user 80 to enter a subscriber user name (step 510). Once the user name is validated, the system asks for the password (step 512), which if provided by the subscriber user the system makes available the add professional name/company or comment modules (step 505). If the user is an advanced subscription user, the user name will not validate, and the answer returned will be “No”. In this case, the user name is validated as an advanced subscription user (step 550), and if the answer returned is “Yes”, the system prompts for a password (step 555), and on provision of the correct password associated with the user name allows the advanced subscriber user access the previous the add name of company or leave comment modules (step 505) or the post resume, post advertisement or bidding modules (step 545).

If the user is not validated through either process (e.g. the user is not a subscription user or an advanced subscription user) then the system will prompt the user through the registration process. In the registration process the user is asked to enter their first and last name (step 515), their complete address including postal or zip code (step 516), their gender (step 518), age group (step 520), a valid email address (step 522) (collectively referred to as the “identification fields”). The user then selects a user ID (step 524) and password (step 526). When a password is selected, it is stored in database server 20, which generates a random message (step 530), which has to be reentered by user 80 (step 535).

After this process the system asks user 80, if he/she wishes to gain unlimited access to home page (step 580), and if the answer provided is “No”, then the allows user to enter the user name and password (step 510), for access to the permitted modules. If the answer is “Yes” then the system prompts the user to provide information for additional information fields, and the user 80 can provide a type of credit card (step 560), the number of the credit card (step 565) and its expiry date (step 570) (collectively referred to as the “financial information fields”), which are stored on secure server 30. The user ID acquired after this process will allow the user to access all of the modules available from the home page, and this user ID will be entered in a separate database from subscription user ID database.

If the initial selection by the user is for the post resume, post advertisement or bidding modules, then the system will ask for the user name from the advanced subscription database. If the user name is validated and the answer provided is “Yes”, the system requests the password from the user (step 555). After provision and validation of the password, the user can proceed to any module. But if the answer is “No” then the system will proceed to the registration process and request the entry of information for the identification fields (beginning at step 515) and the financial information fields (beginning at step 560). If the user provides a subscription user name, then system will bring out the previously filled in registration fields along with the blank financial information fields. When the user provides the required financial information as described above, the information entered in the financial information fields is stored in secure server 30. The outcome of this process will be either the previously acquired subscription user name will be upgraded to an advanced subscription user name, or if there was no previous user ID, a new advanced subscription user ID is issued.

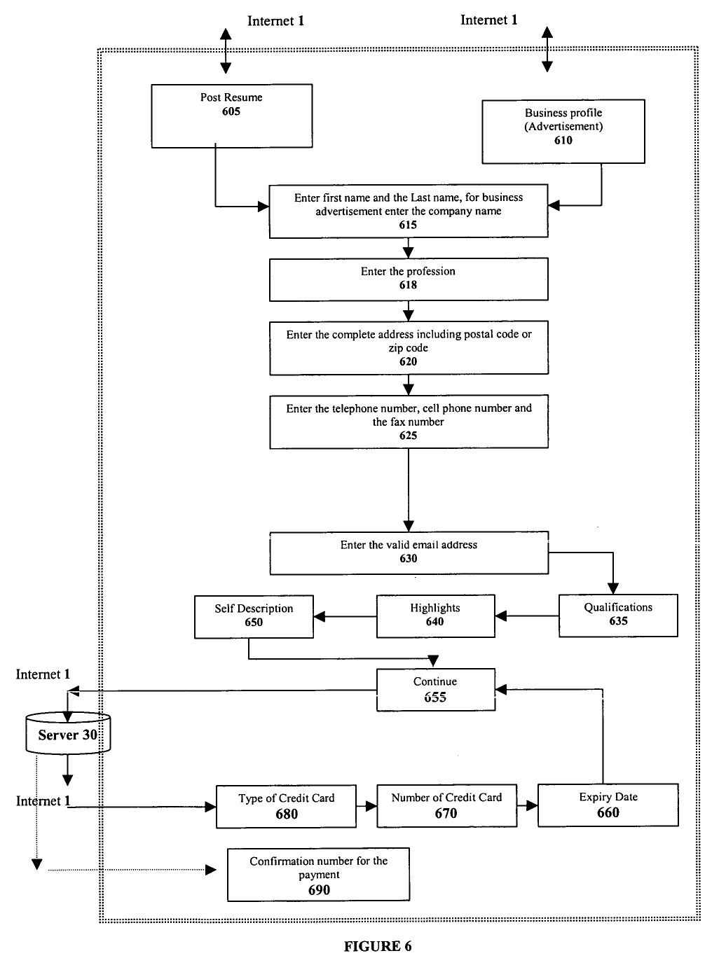

The process for posting a resume or an advertisement is shown in FIG. 6. The user 80 selects to either post a resume (step 605) or an advertisement (or a business profile) (step 610). In either case the user 80 has to enter the first and the last name or in case of business the business entity name (step 615). The user then enters the profession (step 618), the complete address including postal or zip code (step 620), the telephone number, cell phone number and fax number (step 625), and a valid email address (step 630). The user should then enter his or her qualifications (step 635), career highlights (step 640) and a written self-description (step 650). At this point the user will be prompted to continue (step 655) and should they do so, the information entered will be stored in secure server 30, and secure server 30 will obtain financial information for payment from user 80, including the type of credit card (step 680), the number of the card (step 670) and its expiry date (step 660). This information may be taken directly from the user or using the user's record stored in secure server 30. Again, the user 80 will be prompted to continue and once doing so the financial information will be used to process payment and to generate a confirmation number (step 690) for the transaction.

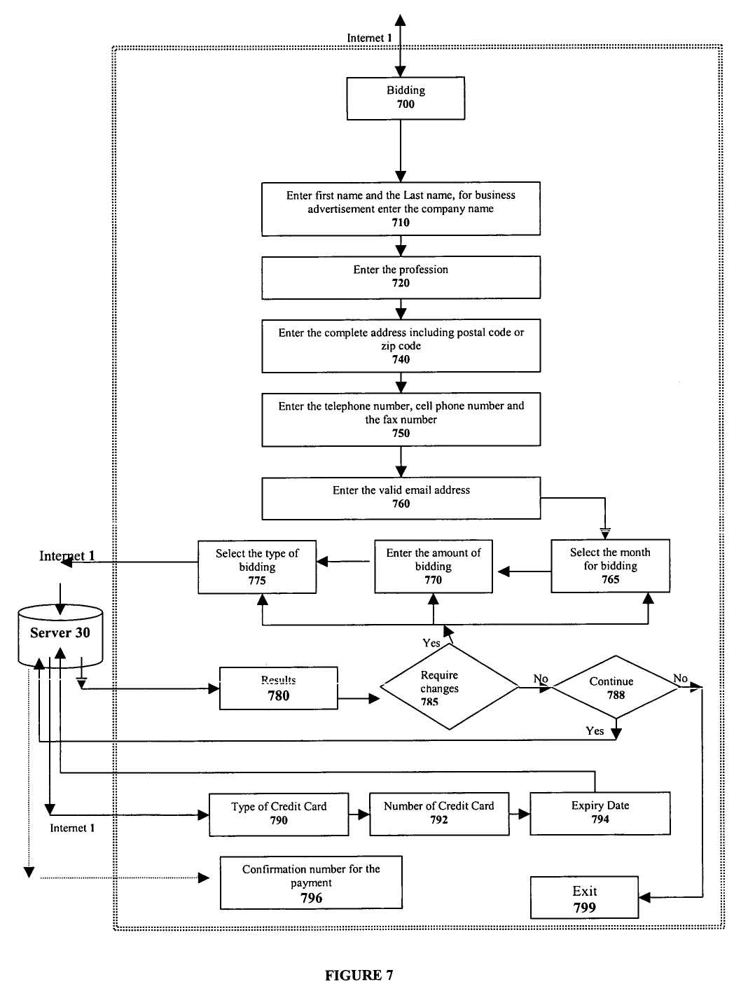

The process by which users bid on an opportunity to place an advertisement is shown in FIG. 7. When a user selects the bidding option (step 700), the user enters their first and last name or in case of business the company name (step 710). The user then enters the profession (step 720), the complete address including postal or zip code (step 740), their telephone number, cell number and the fax number (step 750), and a valid email address (step 760). The user then selects the time period (preferably a month) month for which the advertisement will run (step 765), the amount of the bid (step 770) and the type of advertisement for the bid (step 775). In a preferred embodiment, there are four main types of advertisements to bid on: banner advertisements, text advertisements, box (i.e. full page) advertisements, and any of the preceding types of advertisements. The bidder will be able to make one or multiple selections at this stage. This information is stored in secure server 30, and the server will send back and display the information provided (step 780). The system will ask the user 80 if changes are required (step 785), and if the user responds “yes” then user 80 can make changes in the month (step 765), amount of bid (step 770) and/or the type of bid (step 775). If there are no changes required then system will ask the member to continue (step 788), and if user 80 responds “yes” the system will submit the provided information to secure server. If the user 80 responds “no” then the user will exit the module (step 799) and return to the home page. When the information is submitted to secure server 30, the secure server will bring forward the financial information previously provided by the advanced subscription user 80. The user can then enter the type of credit card (step 790), the number of the credit card (step 792) and its expiry date (step 794) or confirm the already provided options. Once this information is submitted to secure server 30, secure server 30 will obtain a confirmation number 796 after processing payment.

At the end of each month the highest bidder will “win’ the auction, and the user's advertisements will be displayed during searches and on the web site. Furthermore, it is possible to provide advertisements based on search terms, for example so that a law firm's advertisements will be displayed when a user is searching for a law firm. Searches can also be based on geographical inputs, so for instance, a law firm in a particular city will have its advertisements displayed only when a user is searching for a law firm in that particular city.

Although the particular preferred embodiments of the invention have been disclosed in detail for illustrative purposes, it will be recognized that variations or modifications of the disclosed apparatus lie within the scope of the present invention.

What is claimed is:

1. A method of rating a professional comprising:
(a) providing a database, said database containing a plurality of records, each of said records relating to a professional, each of said records storing the name and contact information of said professional;
(b) searching through said database for a particular professional using a web site;
(c) if said professional is present in a record in said database, providing a rating for said professional; and
(d) if said professional is not present in a record in said database, providing the name and contact information of said professional to said database, and providing a rating for said professional.

2. The method of claim 1, wherein said rating may be based on the expertise of said professional, the cost of said professional or the ethics of said professional.

3. The method of claim 2 wherein step (b) further comprises:
selecting a category of professionals.

4. The method of claim 3 wherein step (b) further comprises:
selecting a subcategory of professionals.

5. The method of claim 4, wherein step (b) further comprises:
selecting a geographic area for said professional.

6. The method of claim 5 wherein said web site is accessible to users searching for said rating of said professional.

7. The method of claim 6 wherein said web site provides an advertisement.

8. The method of claim 7 wherein a second professional bids on said advertisement.

9. The method of claim 8, wherein said second professional, if successful in said bid, may select said advertisement for display on said web site.

10. The method of claim 9, wherein in step (c) a comment may be provided in addition to said rating.

11. A system for rating professionals, comprising:
(a) means for storing information about a plurality of professionals in a database, including a name and contact information of each of said professionals;
(b) means for a user to search said database via a web site;
(c) means for said user provide the name and contact information of a professional to said database; and
(d) means for said user to provide a rating of said professional.

12. The system of claim 11, wherein said rating may be based on the expertise of said professional, the cost of said professional or the ethics of said professional.

13. The system of claim 12 wherein said means for said user to search said database comprises selecting a category of professionals.

14. The system of claim 13 wherein said means for said user to search said database further comprises selecting a subcategory of professionals.

15. The system of claim 14, wherein said means for said user to search said database further comprises selecting a geographic area for said professional.

16. The system of claim 15 wherein said web site is accessible to a second user to access said rating of said professional.

17. The system of claim 16 wherein said web site provides an advertisement.

18. The system of claim 17 further comprising means for a second professional to bid on said advertisement.

19. The system of claim 18, wherein said second professional, if successful in said bid, may select said advertisement for display on said web site.

20. The system of claim 19, further comprising means to provide a comment about said professional.
